(19) United States
(12) Patent Application Publication
(10) Pub. No.: US 2008/0036305 A1
(43) Pub. Date: Feb. 14, 2008

(54) High efficiency linear motor and oil well lift device

(76) Inventor: Davor Jack Raos, Vista, CA (US)

Correspondence Address: DAVOR J. RAOS, 2151 RIVIERA DRIVE, VISTA, CA, 92084, US

(21) Appl. No.: 11/891,971

(22) Filed: Aug. 14, 2007

Related U.S. Application Data
(60) Provisional application No. 60/837,184, filed on Aug. 14, 2006.

(51) Int. Cl. H02K 41/02

(52) U.S. Cl. 310/14; 166/66.4

(57) ABSTRACT

A high-efficiency permanent magnet linear motor optimized for low speed, high thrust applications, and a direct-drive oil well lift device powered by the motor. The motor comprises a high ratio of conductor volume to core cross-section area (14) and a plurality of individual, rectangular core-winding units (22) with a straight flux path through the cores (10) of the winding units.

### CROSS-REFERENCE TO RELATED APPLICATIONS

This application claims the benefit of my Provisional Patent Application Ser. No. 60/837,184 filed Aug. 14, 2006.

### STATEMENT REGARDING FEDERALLY SPONSORED RESEARCH OR DEVELOPMENT

Not applicable.

### SEQUENCE LISTING

Not applicable.

### BACKGROUND OF THE INVENTION

Most prior art linear motors are optimized by design for high resolution positioning, rapid acceleration, high speed, and/or low force ripple. These prior art linear motors yield low energy efficiencies when operated in a high relative thrust/low speed mode. Other prior art linear motors have a closed tubular mechanical configuration that is not optimum for attaching and interfacing to external equipment such as bearings, loads and counterbalances. Tubular linear motors are also limited in terms of energy efficiency in a high relative thrust/low speed mode.

Prior art linear-motor powered oil well surface units for sucker rod actuation suffer from low energy efficiency, and/or poor mechanical packaging in terms of integration of counterbalance, load connection, footprint size and overall height. U.S. Pat. No. 5,196,770 issued to Champs, et al (1993) shows a linear motor powered unit that is powered by a tubular motor. U.S. Pat. No. 6,213,722 issued to Raos (2001) shows a linear motor of a non-tubular type but gives insufficient information on the motor design to allow one to make a motor sufficiently efficient for this type of service. Note that the present invention relates to oil well surface units used with sucker rods and a downhole barrel pump, as opposed to subsurface units that do not actuate a sucker rod, and where the entire motor is located at or near the bottom of the well.

### BRIEF SUMMARY OF THE INVENTION

The present invention is an electric linear motor optimized for applications such as oil well pumping where high energy efficiency in the high thrust/low speed mode must be provided together with low cost and where an open, non-tubular mechanical configuration is advantageous.

The proportion and geometry of the present invention allows the simultaneous attainment of:
1) a high ratio of conductor volume (in cubic inches, for example) to core cross-section or pole face area (in square inches, for example)
2) minimized mean winding turn length
3) close proximity of the mean winding to the core

The present motor design enables a direct-drive surface unit for rod pumped oil wells that for the first time simultaneously provides high energy efficiency, a small footprint, minimum overall height, and low cost of manufacture. These are critical parameters for this application, especially for use in unconventional, intraresidential, offshore, etc. fields. The present invention represents a substantial advancement in overall economics with respect to this industry.

### BRIEF DESCRIPTION OF THE DRAWINGS

FIG. 1 provides a side section view of a single-phase linear motor according to the present invention.

FIG. 2 provides a transverse section view of a single-phase linear motor according to the present invention.

FIG. 3 provides a perspective view of a rectangular core/winding unit, showing the dimensions used in calculating the conductor volume to core cross-section area ratio.

FIG. 4 provides a side section view of a two-phase linear motor according to the present invention, showing two permanent magnet assemblies joined side by side with staggered pole positions.

FIG. 5 provides a side section view of a two-phase linear motor according to the present invention, showing two permanent magnet assemblies joined end to end with staggered pole positions.

FIG. 6 provides a perspective view of an oil well surface unit with a motor comprising one column of core/winding units.

FIG. 7 provides a top view of an oil well surface unit with a motor comprising one column of core/winding units.

FIG. 8 provides a perspective view of an oil well surface unit with one core/winding support member removed to reveal underlying core/winding units.

FIG. 9 provides a top view of an oil well surface unit with two columns of core/winding units.

FIG. 10 provides a perspective view of a detail of the oil well surface unit of FIG. 8.

FIG. 11 provides a side section view of an alternate embodiment of a permanent magnet linear motor according to the present invention, showing a toothed-core and non-overlapping windings.

### REFERENCE NUMERALS IN DRAWINGS

10 laminated steel core
12 winding
14 core cross-section area
16 core/winding unit length dimension
18 core/winding unit width dimension
20 core/winding unit height dimension
22 individual core/winding unit
24 permanent magnet
26 moving magnet assembly
28 flux path
30 motor frame
32 linear bearing
34 core/winding unit support member
36 pneumatic counterbalance
38 polished rod
40 hydraulic control cylinder
42 longitudinal core member
44 H-shaped moving magnet assembly
46 C-shaped motor frame
48 multi-toothed core
50 teeth

### DETAILED DESCRIPTION OF THE INVENTION

A detailed discussion of the various embodiments of the present invention, with reference to the accompanying drawings, will illustrate the concept of the present invention.

### High Efficiency Linear Motor

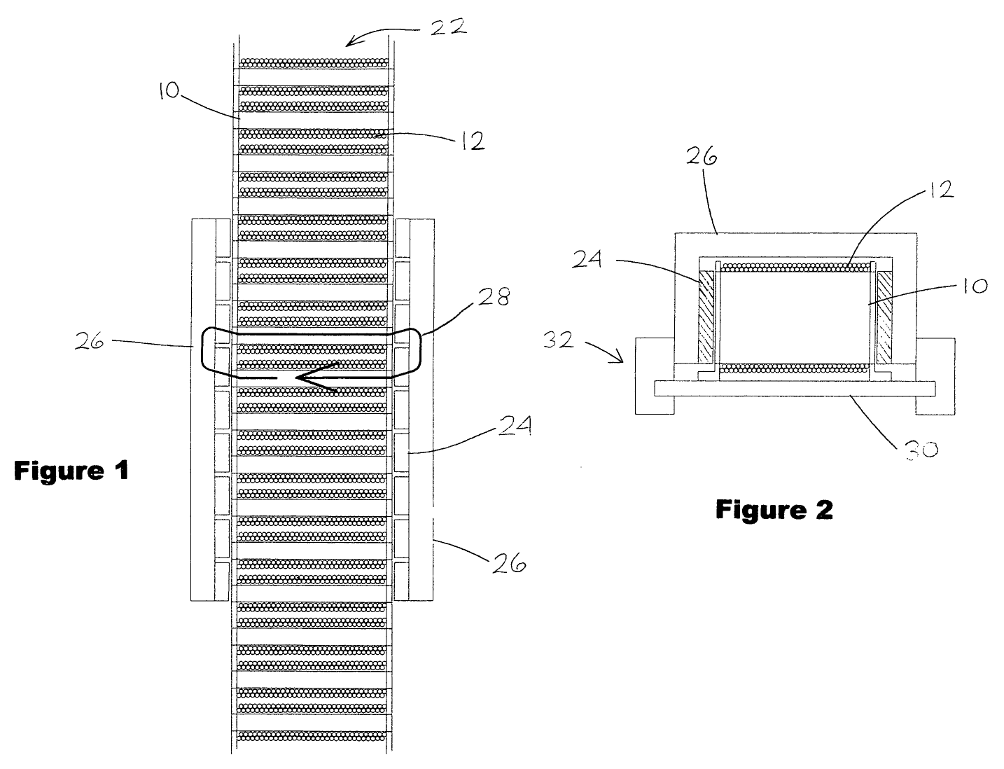

An embodiment of the motor of the present invention is illustrated in FIG. 1 (side section view) and FIG. 2 (end view), which show a single-phase permanent magnet linear motor with permanent magnets 24 mounted in moving magnet assembly 26, in opposition to the ends of laminated steel cores 10 and windings 12, whose flux axes, as shown by flux path 28, are perpendicular to the direction of travel. Laminated steel cores 10 are mounted rigidly with respect to motor frame 30. The moving magnet assembly is supported by linear bearing 32.

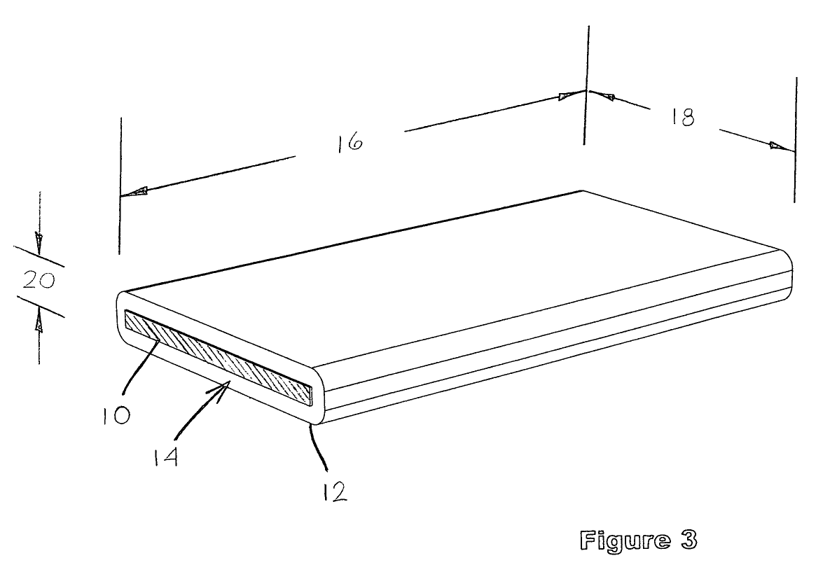

FIG. 3 shows a perspective view of an individual core/winding unit, a length dimension 16, a width dimension 18, a height dimension 20, a laminated steel core 10, a core cross-sectional area 14 (crosshatched), and a winding 12.

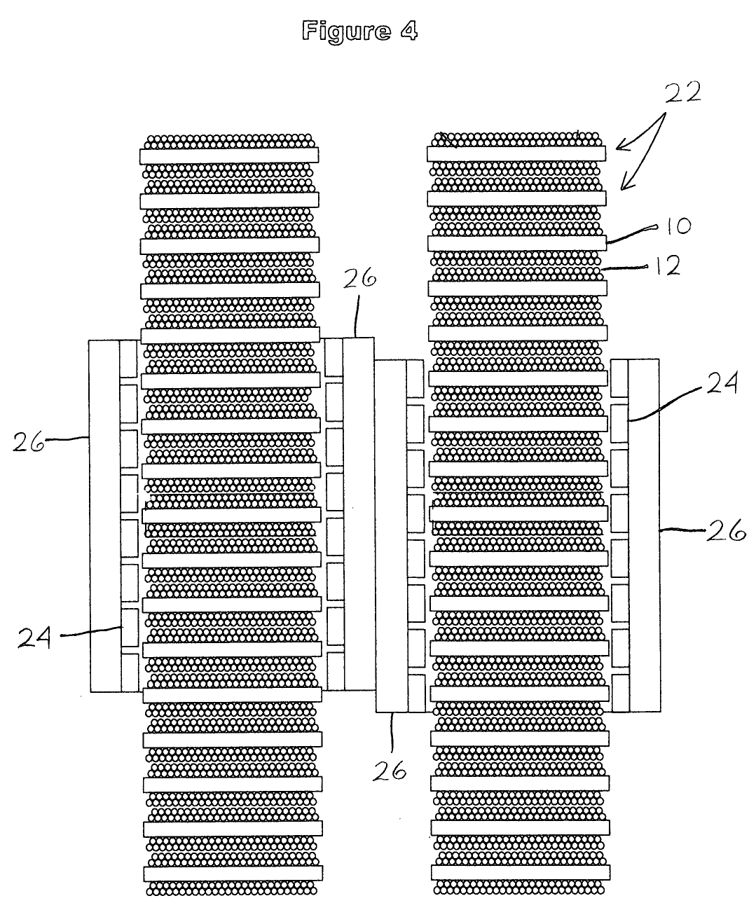

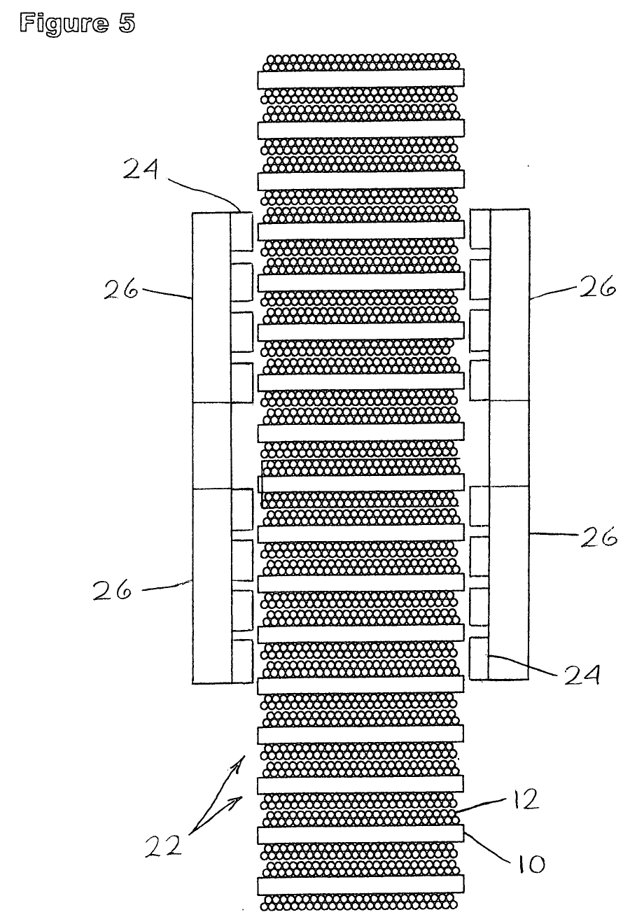

FIGS. 4 and 5 (side section views) show a two-phase motor with two moving magnet assemblies 26. Permanent magnets 24 are mounted to the moving magnet assemblies 26 so that the pole positions of each assembly are staggered relative to each other. Permanent magnets 24 react with both ends of individual core/winding units 22, each composed of winding 12 and laminated steel core 10.

FIG. 11 (side section view) shows an alternate embodiment of a permanent magnet linear motor with moving magnet assembly 26 slidably mounted with respect to multi-toothed core 48, which is composed of a longitudinal core member 42 and a plurality of teeth 50, each of which is wrapped in a winding 12.

In the favored embodiment, the motor comprises a first assembly containing individual rectangular core/winding units, carrying flux transversly to the direction of motion, and a second assembly containing high-energy permanent magnets, which moves relative to the first assembly, supported and guided by a linear bearing. The permanent magnets react with both poles of the multiple core/winding units simultaneously. The windings are non-overlapping. The core/winding units function as individual electromagnets, commutated in a bipolar fashion, and so that successive units are magnetized in opposite directions. The pitch of the permanent magnet poles and the core/winding units is equal or nearly equal—each magnet does not overlap several electromagnet poles as in overlapping-winding motor designs.

In the favored embodiment, the length of each of the core/winding units of the present invention is greater than the length of the corresponding electromagnetic structure of prior art linear motors, when both are scaled to an equivalent rated operating output power. The ratio of the volume of conductor to core cross section is also greater in the present invention. The aspect ratio of the core/winding units (length parallel to flux path divided by the cross-section area) will likewise be generally greater in the present invention. (“Corresponding electromagnetic magnetic structure” as used here refers to the wound core portions of prior art motors, not including the sections of core not covered by windings.)

Various conductor materials can be used, such as copper, aluminum, or silver; depending on their specific resistance, each would require various volume ratios to provide equivalent efficiency.

Another way to characterize the present motor design is to say that a sufficient ratio of conductor volume to pole face or core cross section area is provided, so that under conditions of high flux saturation levels of the core (corresponding to high relative thrust), and when the speed of the moving part of the motor is in the range of 30 to 60 cm per second, the energy loss due to winding resistance is no more than approximately 40 to 50 percent of the total energy input of the motor. The target in the preferred embodiment for the oil lift application is approximately 20 percent losses, in other words, a motor efficiency of 80 percent. (The numbers mentioned here reflect the inventorsr's current estimation and are meant only as a guide for visualizing the ranges being spoken of and to add a sense of proportion relative to prior art.)

Another aspect of the present motor is that the conductor volume, and minimized mean winding turn length targets of this design, lead to windings of relatively shallow depth, with the result that pole spacing is close (small pole pitch) and the dimension of the pole face is short in the direction of motor travel. Smaller pole pitches thus aid in reduction of resistance per unit thrust, but a practical limit is reached as the core and commutation switching losses increase due to switching frequency increases due to faster commutation rates. The optimum compromise is currently believed by the inventor to be a pitch of approximately 1 to 3 cm for a motor speed of 60 cm per second, which is typical of the speed range for many oil lift applications.

The motor geometry further allows the cores to be wound individually, i.e., “bobbin” wound, and then placed into the motor structure, which enables high density, high fill factor windings to be made at minimum cost. The optional installation of square or other non-round cross-section wire is likewise facilitated by this configuration, enabling a further increase in winding density.

The flux path through each rectangular core is substantially straight and direct from pole face to pole face, allowing the use of grain-oriented lamination steel, which provides a higher performance/cost ratio than non-oriented steel. The core is fabricated by simple transverse shearing of lamination strip stock and yields no cutting waste. These features together allow a maximization of flux density per unit electrical power input at minimum total cost of manufacture.

These design elements lead to increased efficiency in the high thrust and low speed mode compared to prior art, due to a reduction in resistance losses per unit flux (thrust) that is produced. In other words, at high flux levels and slow speeds, more conductor volume per unit thrust must be employed to achieve high efficiency as compared to the conductor volume needed to achieve high efficiency in a typical prior art motor operating at high speed. It is important to note that in the latter case the motor may be dissipating the same amount of heat from the windings as in the present motor, but that energy loss will represent a smaller fraction of the total energy input, because speed is greater, and more work is being done at a given thrust level, and thus the typical motor retains good efficiency at high speed with much less conductor volume.

Another embodiment of the present invention represents an adaptation of prior art motors to gain some of the benefit of the favored embodiment. In this embodiment, the wound stator may alternatively be constructed as per FIG. 11, wherein the parts, commonly called “teeth”, corresponding to the cores of the favored embodiment are joined to one another along a longitudinal plane of the motor. In this embodiment, the present invention is differentiated from the prior art by the substantially longer winding-covered core sections, when scaled to a similar motor output power, combined with the use of non-overlapping windings.

In the foregoing embodiments, the assembly containing permanent magnets can be the moving part and this part can be shorter than the wound stator (measured in the direction of travel). The stator windings are then switched so that only the windings near the moving magnets are energized at any one time. Alternately, the part containing permanent magnets can be the stationary part, while the core/windings move, with a flexible cable or sliding brushes supplying power to the windings.

The motor can further be made in a multi-phase form by constructing the thruster or stator with two or more sections joined together. The pole face position and energization timing (commutation) of each section is staggered or offset relative to the others, for the purpose of reducing force ripple and providing self-starting ability. An alternate form for multi-phase operation employs a core/winding unit assembly with a pole pitch slightly different than the permanent magnet assembly, with corresponding commutation timing.

The configuration of the present invention facilitates the attachment and interface of external equipment, such as a bearing system, a counterbalance, and/or a load, directly to the side of the moving part of the motor, which enables optimum packaging efficiency for some applications.

### High Efficiency Linear Motor-Powered Oil Well Lift Device

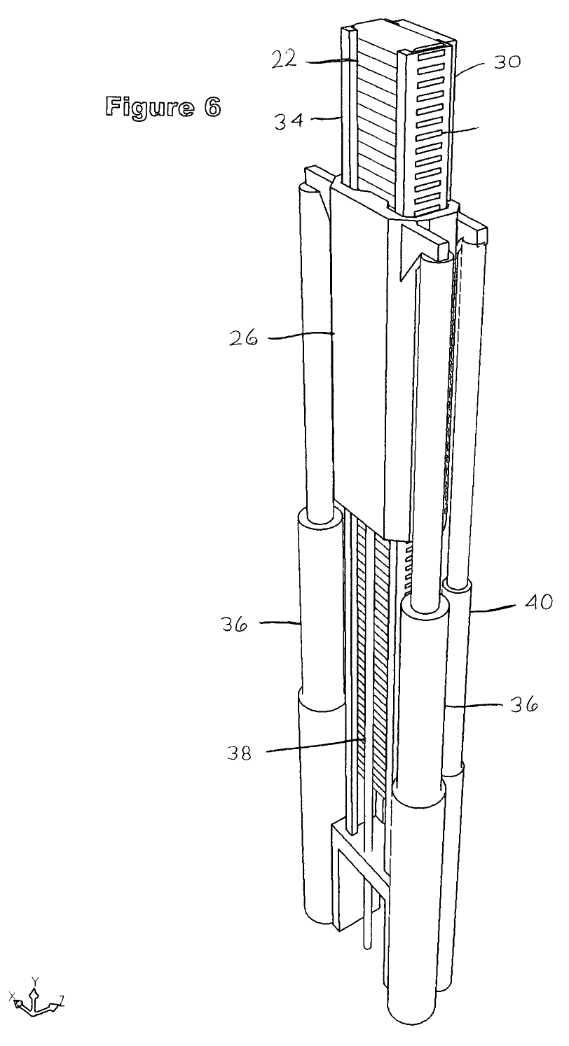

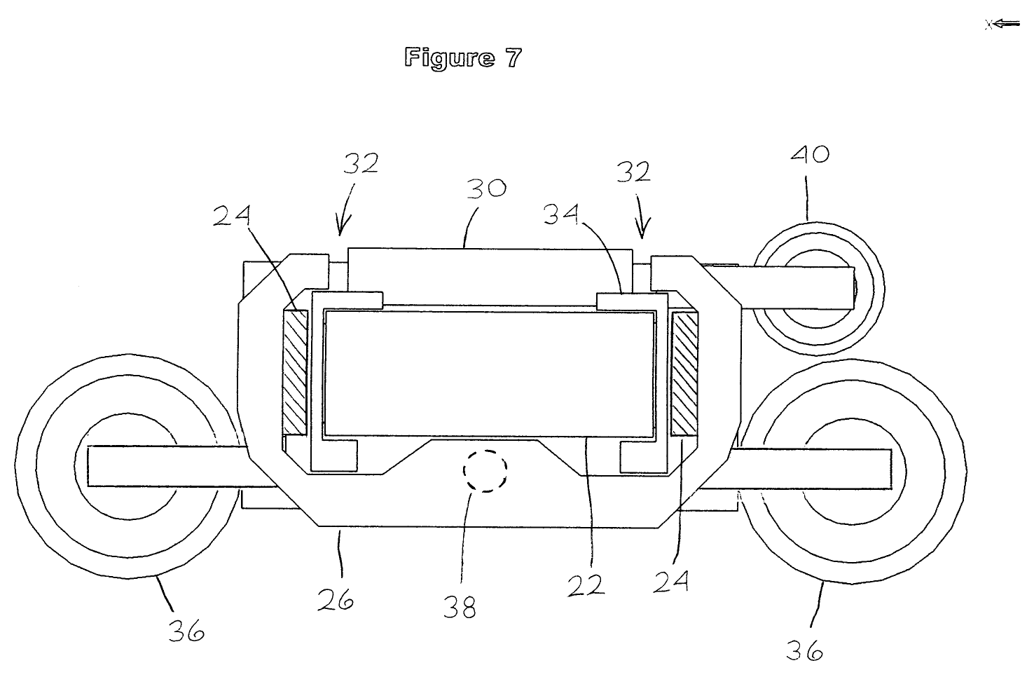

FIG. 6 (perspective view) and FIG. 7 (top view) show an oil well surface unit with a motor comprising permanent magnets 24 mounted in moving magnet assembly 26, supported by linear bearing 32, and one column of individual core/winding units 22 supported in core/winding unit support member 34. Polished rod 38, pneumatic counterbalance 36, and hydraulic control cylinder 40 are attached to moving magnet assembly 26.

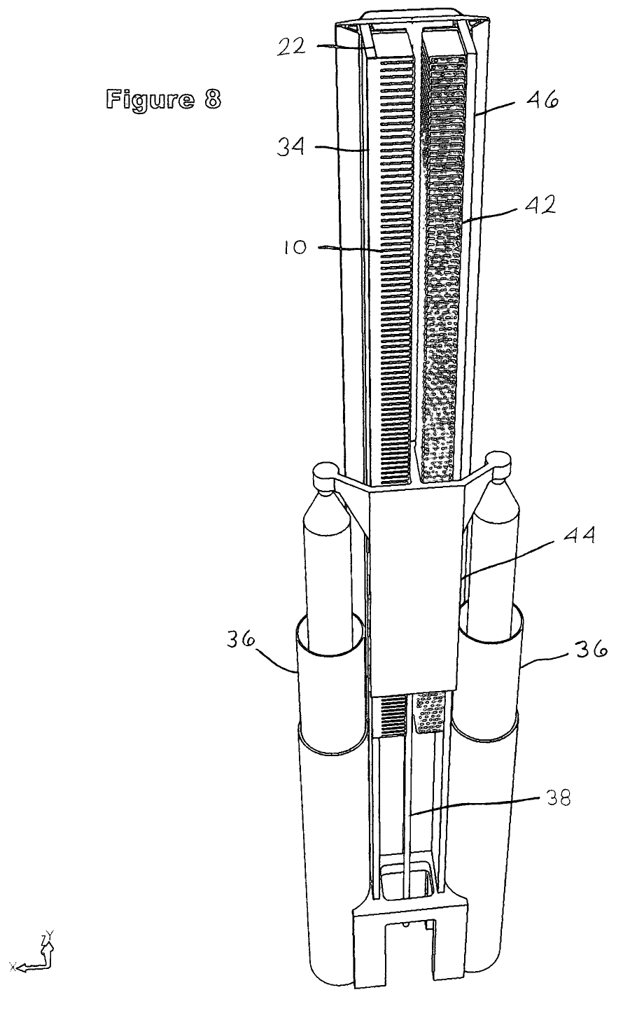

FIG. 8 (perspective view) shows an oil well surface unit with one core/winding support member removed. An H-shaped moving magnet assembly 44 is slidably mounted with respect to two columns of individual core/winding units 22. Core/winding unit support member 34 holds individual core/winding units 22 and is itself rigidly mounted with respect to C-shaped motor frame 46. Polished rod 38 and pneumatic counterbalances 36 are attached to H-shaped moving magnet assembly 44.

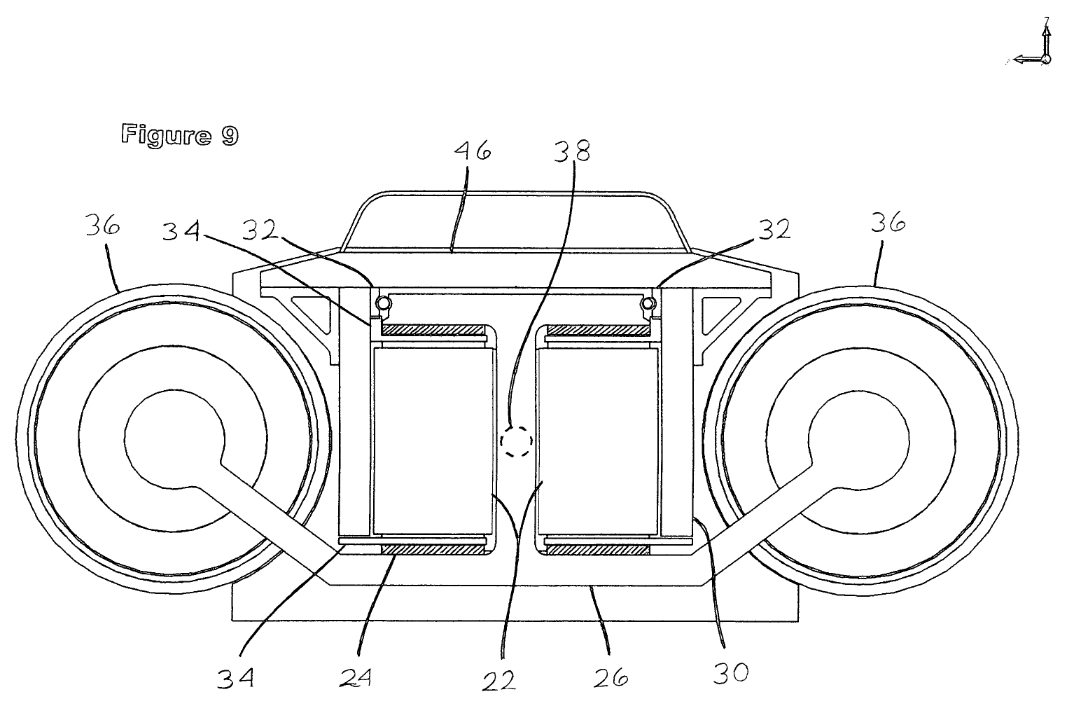

FIG. 9 (top view) shows an oil well surface unit with an H-shaped moving magnet assembly 44, supported by linear bearing 32, and two columns of individual core/winding units 22 supported by core/winding unit support members 34, which are themselves rigidly mounted with respect to C-shaped motor frame 46. Polished rod 38 and pneumatic counterbalances 36 are attached to H-shaped moving magnet assembly 44.

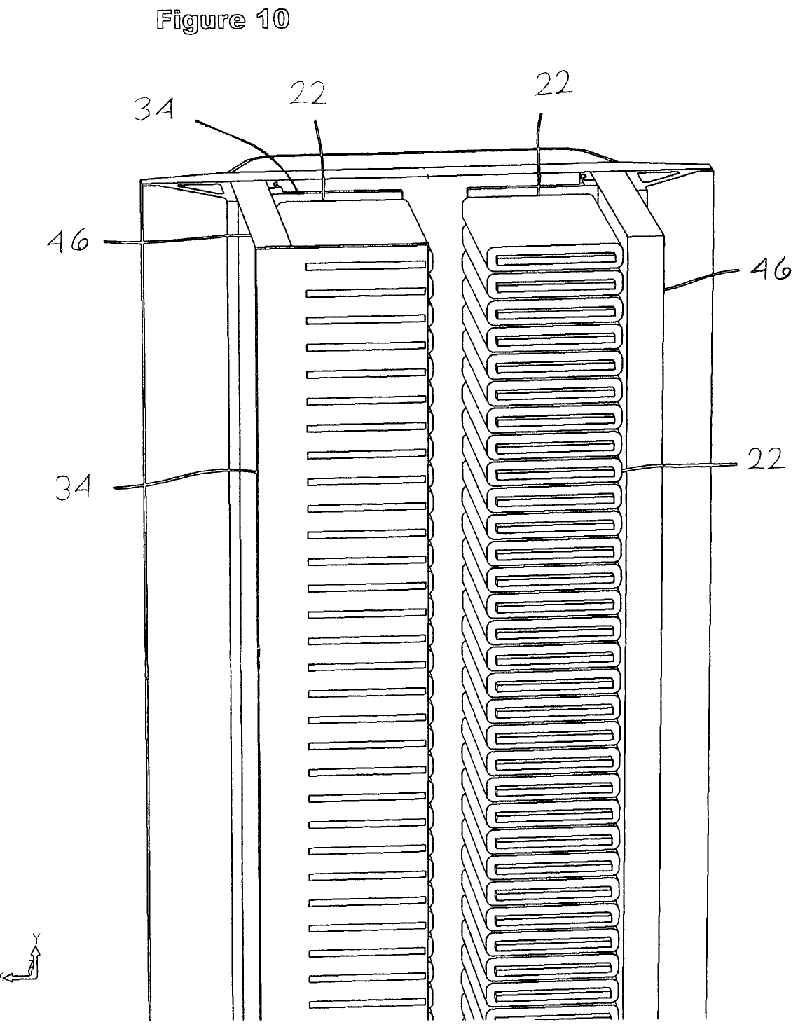

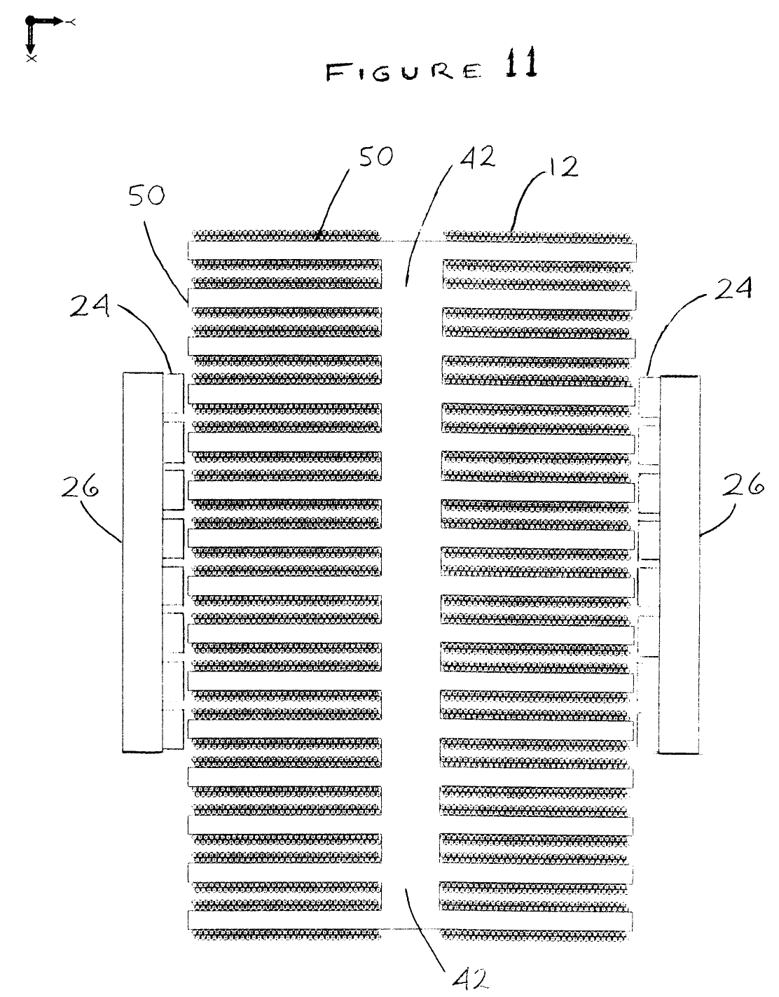

FIG. 10 (perspective view) shows a detail of the oil well surface unit of FIG. 8. Two columns of individual core/winding units 22 are supported by core/winding support members 34, which are themselves rigidly mounted with respect to C-shaped motor frame 46.

The motor can be operated in a vertical orientation and combined with a counterbalance, for example a pneumatic cylinder, for reciprocating a relatively large mass in the vertical direction with low motor power. In this case, the static equilibrium point of the mass and counterbalance can be arranged to be away from the ends of the stroke, and the motor can set the system into reciprocating motion by starting with oscillations of short displacement that gradually gain amplitude until the full stroke length is reached, thus maximizing the mass that a given motor size can handle.

One embodiment comprises two columns of core/winding units mounted in a static C-shaped (viewed in cross section) frame, and an H-shaped (viewed in cross section) moving-magnet assembly. This configuration (and similar variations with like symmetry) are advantageous for use in an oil well surface unit as they allow the polished rod to attach to the moving-magnet assembly at a point aligned with the center of motor thrust, thus greatly reducing loads on the linear bearing of the motor while keeping overall unit height to a minimum.

When used in an oil well surface unit application, the commutation of the motor in the preferred embodiment is by solid state switches and is controlled by a microprocessor, according to a program that is user adjustable to best adapt to the conditions of each particular well. The commutation may alternately be accomplished by brushes or other means.

One or more vertical small-diameter hydraulic cylinders, or other mechanical means such as a ratchet mechanism, can be used to control the acceleration of the motor moving part in case of counterbalance system or rod failure, and also to provide positioning means during rigging and servicing. Such a cylinder could be attached to the base of the machine, and the rod attached at its top to the moving part of the motor, in a similar fashion to the pneumatic counterbalance cylinders.

It is instructive to note that a prior art motor with no modification may be employed to attempt to meet the slow speed high efficiency requirements of some applications by simply scaling the motor far beyond its usual size, in other words, using a very large motor and running it at a power output far below its intended maximum design rating. This strategy may improve efficiency, but the motor will be much larger and more expensive than the present invention, and the inventor currently believes, also not capable of reaching the efficiencies attainable by the present invention. It is further instructive to note that a prior art motor wound with a superconductor of sufficiently high critical temperature and low cost (currently unavailable) may be capable of efficiencies and unit cost similar to the present invention, in the slow speed/high thrust mode, even without oversizing as described above.

Although the above description contains may specificities, these should not be construed as limitations on the scope of the invention, but rather as an exemplification of one preferred embodiment thereof. Many other variations are possible. For example, other potential uses for the motor design, which share many of the requirements of oil lift, are elevator drive linear motors, for use in very tall buildings for example, and catapult drives for aircraft launching on military ships. Accordingly, the scope of the invention should be determined not by the embodiment(s) illustrated, but by the appended claims and their legal equivalents.

I claim:

1. A permanent magnet linear motor, the motor comprising:
a plurality of individual, rectangular core/winding units with non-overlapping windings.

2. The motor of claim 1 wherein said core/winding units have a length of 4 cm or longer.

3. A permanent magnet linear motor, the motor comprising:
a multi-toothed core; and
non-overlapping windings, wherein the length of the winding-covered part of each tooth is 4 cm or longer.

4. A permanent magnet linear motor, the motor comprising:
a plurality of individual core/winding units; and
non-overlapping windings, wherein each said core/winding unit has a ratio of conductor volume to core cross-section area in the range of 2:1 to 3:1.

5. The motor of claim 4 wherein said ratio is in the range of 3:1 to 5:1.

6. The motor of claim 4 wherein said ratio is in the range of 5:1 to 12:1.

7. The motor of claim 4 wherein said ratio is in the range of 12:1 to 20:1.

8. The motor of claim 4 wherein said ratio is in the range of 20:1 or more.

9. A permanent magnet linear motor, the motor comprising:
a multi-toothed core; and
non-overlapping windings, wherein the ratio of the conductor volume of each winding to a corresponding tooth cross-section area is in the range of 2:1 to 3:1.

10. The motor of claim 9 wherein said ratio is in the range of 3:1 to 5:1.

11. The motor of claim 9 wherein said ratio is in the range of 5:1 to 12:1.

12. The motor of claim 9 wherein said ratio is in the range of 12:1 to 20:1.

13. The motor of claim 9 wherein said ratio is in the range of 20:1 or more.

14. A device for directly actuating a rod of an oil well sucker rod pump assembly, the device comprising:
a permanent magnet linear motor, the motor including a plurality of individual, rectangular core/winding units; and
non-overlapping windings; and
a counterbalance.

15. The device of claim 14 wherein each said core/winding unit has a ratio of conductor volume to core cross-section area in the range of 2:1 to 3:1.

16. The device of claim 14 wherein each said core/winding unit has a ratio of conductor volume to core cross-section area in the range of 3:1 to 5:1.

17. The device of claim 14 wherein each said core/winding unit has a ratio of conductor volume to core cross-section area in the range of 5:1 to 12:1.

18. The device of claim 14 wherein each said core/winding unit has a ratio of conductor volume to core cross-section area in the range of 12:1 to 20:1.

19. The device of claim 14 wherein each said core/winding unit has a ratio of conductor volume to core cross-section area is 20:1 or more.

20. The device of claim 14 wherein said linear motor comprises two columns of said core/winding units, and wherein said rod reciprocates in a space between said two columns.

21. A device for directly a rod of an oil well sucker rod pump assembly, the device comprising:
a multi-toothed core; and
non-overlapping windings, wherein the ratio of the conductor volume of each winding to a corresponding tooth cross-section area is in the range of 5:1 or more; and
a counterbalance.
